(19) United States
(12) Patent Application Publication
(10) Pub. No.: US 2018/0155117 A1
(43) Pub. Date: Jun. 7, 2018

(54) PRODUCT FOR MAKING A DRINK THROUGH INFUSION

(71) Applicant: M.B. SOCIETA' A RESPONSABILITA' LIMITATA, Milano (IT)

(72) Inventor: Marco VERRI, Bologna (IT)

(21) Appl. No.: 15/576,028

(22) PCT Filed: May 25, 2016
(86) PCT No.: PCT/IB2016/053060

§ 371 Date: Nov. 21, 2017

(30) Foreign Application Priority Data
May 26, 2015 (IT) 202015000017965

(51) Int. Cl. B65D 85/804; A23F 5/10

(52) U.S. Cl. CPC B65D 85/8043; A23F 5/10

(57) ABSTRACT

A product for making, through infusion, a respective drink, in particular a hot drink, especially coffee, the drink being preferably obtained by making the infusion in a respective machine which uses an infusion liquid, which is in particular in the form of water, especially in the form of hot water; the product includes a raw infusion material, preferably in the form of roasted and ground coffee, in a compact configuration, that is, it has the respective constituent particles which adhere to each other. The infusion product extends along an axial direction between opposite longitudinal ends and has a peripheral surface, which is convergent towards a respective longitudinal end in such a way as to engage, and match with, the profile of a corresponding inner surface of a suitable infusion container, in particular in the form of an adapter container.

### TECHNICAL FIELD

This invention relates to a product for making a drink through infusion.

### BACKGROUND ART

There are prior art products for making through infusion a respective drink, in particular a hot drink, especially coffee, and wherein the drink is obtained through the infusion in a respective machine which uses hot water.

The prior art products comprise a raw infusion material, in particular of roasted and ground coffee, the raw material being normally inserted in a special container, preferably plastic, possibly in the form of a respective adapter container, which allows the insertion in a suitable infusion machine.

However, these prior art products have the drawback of running the risk of incorrectly positioning inside the adapter container, adversely affecting the infusion and, therefore, the drink.

There are also prior art containers for corresponding raw infusion materials, which are made of rigid biodegradable plastic material, however, these containers require an excessive use of material to obtain a corresponding package of product which is entirely biodegradable and they require an excessive quantity of material to be disposed of.

The making of the raw infusion material in a compacted form is also known in the prior art, that is, having respective constituent particles which adhere to one another; however, the raw material in compacted form is not used in respective adapter containers and is wrapped in a corresponding barrier containment material, by which it is inserted directly in specific infusion machines.

### SUMMARY OF THE INVENTION

This invention therefore proposes a new solution as an alternative to the solutions known up to now and, more specifically, proposes to overcome one or more of the above mentioned drawbacks or problems and/or to meet one or more of the needs felt in the trade or inferable from the above.

A product is therefore provided for making, through infusion, a respective drink, in particular a hot drink, especially coffee. the drink being preferably obtained by making the infusion in a respective machine which uses an infusion liquid, which is in particular in the form of water, especially in the form of hot water; the product comprises a raw infusion material, preferably in the form of roasted and ground coffee, which is preferably designed to be housed in a suitable infusion container, in particular in the form of an adapter container; characterised in that the raw infusion material has a compacted configuration, that is, it has the respective constituent particles which adhere to each other; and in that the infusion product extends along an axial direction between opposite longitudinal ends and has a peripheral surface, or part of this, which extends longitudinally and is convergent towards a respective longitudinal end which is designed to engage a corresponding inner profile of the infusion container.

In this way, it is possible to avoid, or minimise the risk, that the product incorrectly positions itself inside the respective container, in particular the adapter container.

In this way, it is also possible to have a raw material which is easily placed as waste in the organic waste container and which avoids rejecting, or eliminating, an excessive quantity of material.

A container is also provided for the infusion of a respective product for making, through infusion, a respective drink, in particular a hot drink, especially coffee; the drink being preferably obtained through a respective machine which uses an infusion liquid, which is in particular in the form of water, especially in the form of hot water, the container being designed to be inserted a respective seat of the infusion machine; the container comprises a body which extends along a respective longitudinal axis between opposite longitudinal ends and which is internally hollow so as to define a respective chamber for housing the infusion product, the chamber being delimited by a respective perimeter wall of the container body, characterised in that the perimeter wall has a corresponding portion defining means for retaining the infusion product, the portion extending longitudinally and convergent towards a respective longitudinal end of the container body and designed to engage a corresponding outer surface of the infusion product.

In this way it is possible to obtain an excellent drink using an advantageous product, in particular without the need to use and dispose of corresponding containers, and in particular without the need to dispose as organic waste an excessive quantity of material.

### BRIEF DESCRIPTION OF THE DRAWINGS

This and other innovative aspects, or specific advantageous features, are set out in the appended claims and its technical features and advantages are apparent from the detailed description which follows of preferred and advantageous embodiments of it which must be considered purely as non-limiting examples; the description being made with reference to the accompanying drawings, in which:

FIGS. 1A and 1B illustrate perspective views from above and below, respectively, of the preferred embodiment of the container according to this invention with housed a preferred embodiment of the infusion product according to this invention;

FIGS. 2A and 2B are exploded perspective views from above and below, respectively;

FIG. 3 is a longitudinal cross section of the preferred embodiment of the container housing a respective product according to the corresponding preferred embodiment;

FIG. 4 is a longitudinal cross section only of the container according to the respective preferred embodiment of this invention;

FIG. 5 is a top plan view only of the container;

FIG. 6 is a perspective view only of the container.

### DETAILED DESCRIPTION OF PREFERRED EMBODIMENTS OF THE INVENTION

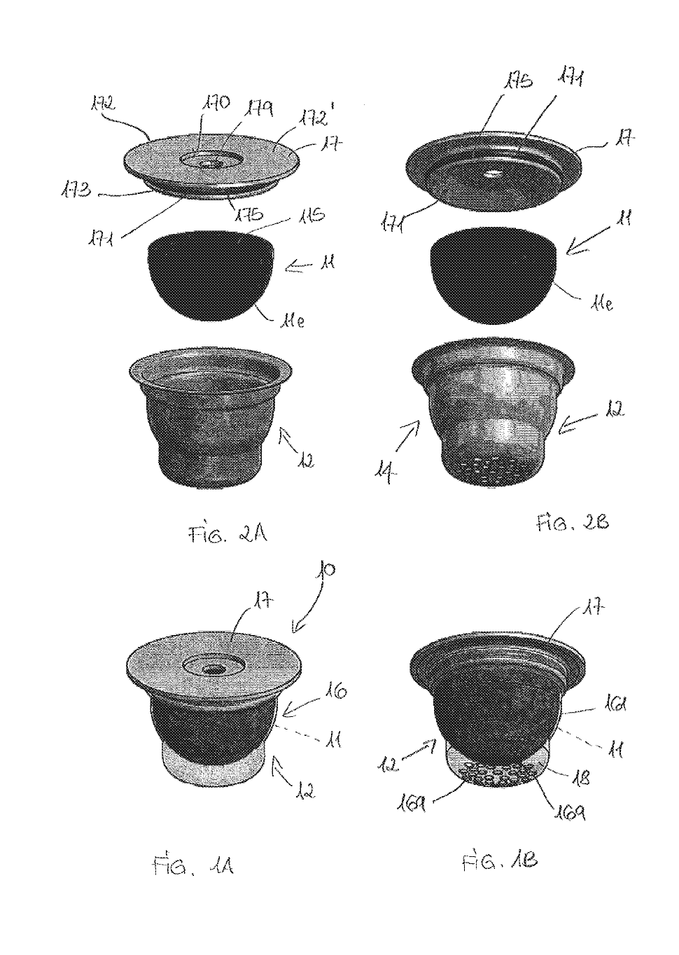

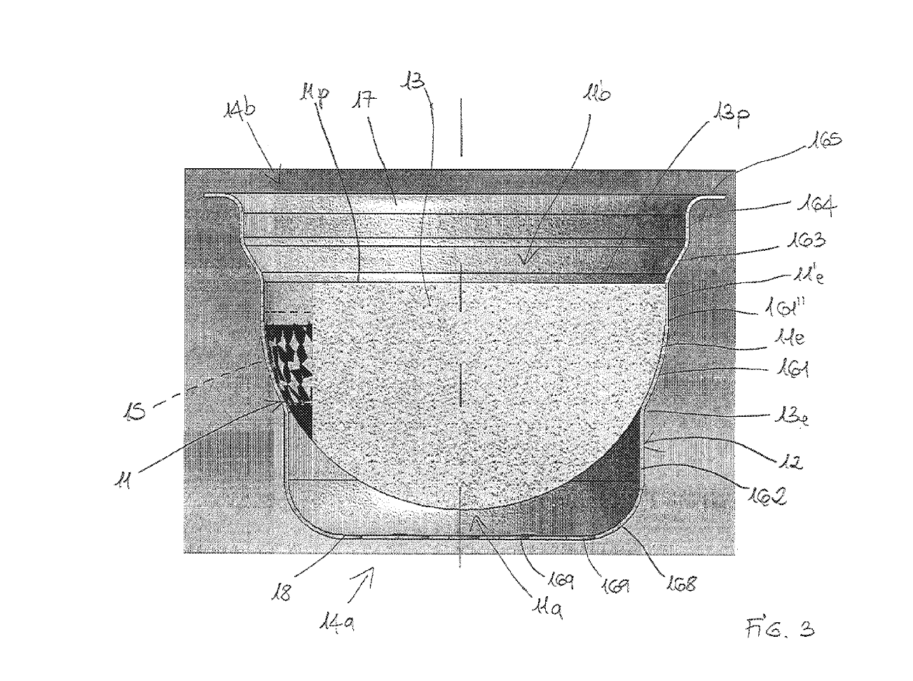

FIGS. 1A to 3 show a preferred embodiment of the product 11 for making, through infusion, a respective drink, in particular a hot drink, especially coffee.

The drink is obtained through the infusion in a respective machine, in which a respective infusion liquid is used, in particular in the form of water, especially in the form of hot water.

The product comprises a raw infusion material 13, which is preferably in the form of roasted and ground coffee, the product being designed to be housed in a suitable infusion container, in particular in the form of an adapter container 12, that is, a container which is designed to be inserted in a respective seat of the corresponding infusion machine.

Advantageously, the outer shape of the container 12 matches, at least, the basic geometrical dimensions and/or the shape of the seat in the respective infusion machine and, in the particular adapter configuration, illustrated here, and which will be described in more detail below, can be preferably be opened for allowing the insertion and removal of the infusion product.

Advantageously, the raw infusion material 13 has a compact configuration, or is in the form of an advantageous tablet, that is to say, it has the respective constituent particles adhering to each other.

As illustrated, the infusion product extends along an axial or longitudinal direction “L” between opposite longitudinal ends 11a, 11b and has a peripheral surface 11e, which, advantageously, extends longitudinally and is convergent towards the respective longitudinal end 11a, in such a way as to engage a corresponding inner profile of the infusion container 12.

In this way, it is possible to easily insert the infusion product into a corresponding container, in particular inside an adapter container 12 as illustrated here, avoiding or minimising the risk that the product 11 itself positions incorrectly in the respective container and adversely affects the successful production of the drink.

Further advantageously, this product 11 comprises a first film 15, in particular in the form of a filtering film, that is, in the form of a film lets pass the infusion liquid, along with the infused product, and which is advantageously made from biodegradable and/or compostable material, preferably food safe.

Advantageously, the wrapping film 15 is made of a PLA and surrounds the compact raw material 13, especially defining the outer surface of the product 11.

Advantageously, the wrapping film 15 surrounds entirely the raw food product infusion material 13.

In this way, each releasing of powder or pieces of the raw infusion material is advantageously prevented.

Moreover, the product 11 may advantageously be placed as waste into a bin for collecting organic or biodegradable waste.

In this way, moreover, the engagement between the product and the inner receiving profile surface of the container has a particularly reduced friction, thus facilitating the positioning of the product inside the container and avoiding or minimising the risk that the product positions incorrectly in the respective container.

Further, the removal of the product from the container is also advantageously facilitated, that is to say, the consequent separating from this, in view of the disposal in a corresponding organic or compostable waste collector.

Advantageously, as illustrated, the product has a peripheral surface 11e, or part 11′ thereof, which is hemispherical or generally hemispherical in shape.

In this way, it is possible insert, even more easily, the infusion product into the container, in particular inside the adapter container 12, avoiding or minimising the risk that the product 11 itself positions incorrectly in the respective container and adversely affects the successful production of the drink.

Moreover, in this way, the quantity of infusion product which is contained inside the product is maximised, making it possible to obtain an infused product which is of particularly advantageous quality.

As illustrated, the product 11 has a portion 11′ of the peripheral surface, the portion being cylindrical or generally cylindrical in shape.

As illustrated, the hemispherical or generally hemispherical portion 11′ extends from the cylindrical or substantially cylindrical portion 11″.

As illustrated, the product 11 also has a respective large end face 11p, in particular flat.

Advantageously, this end face 11p is designed to be struck by the flow of infusion liquid which enters inside the container in which the product 11 is used, the flow of infusion liquid in use passing through the end face 11 and entering in the raw infusion material 13, infusing the raw material in the liquid.

Advantageously, the wrapping film 15 therefore defines the outer face 11e of the product, and in particular therefore has a hemispherical or generally hemispherical configuration, at a corresponding end portion of the outer surface of the product.

More specifically, the wrapping film 15 also has a cylindrical or generally cylindrical portion at the respective cylindrical outer face of the product.

Moreover, as illustrated, the wrapping film 15 also defines the flat end face of the product, defining a corresponding transversal flat portion.

Advantageously, the wrapping film 15 adheres to the raw infusion material, in compact form, in particular in particular adhering completely to the outer lateral surface 13e of the raw material and/or the transversal end surface 13p of the raw material.

More specifically, therefore, advantageously, the wrapping film 15 adheres completely to the entire outer surface of the raw material 13.

The tablet of raw infusion material 13, having the wrapping film 15 adhering to this, is obtained from respective particles, in particular in the form of powder, granules, pieces and/or the like, the raw material being inserted in the film 15 and subjected to ultrasound energy, until a compact configuration, or tablet, of the infusion material is obtained, with the film adherent to the raw material.

Although not illustrated in detail in the accompanying drawings, it is also imaginable that the wrapping film 15 has a protruding peripheral edge, in particular extending from the respective end face 11p of the product, the protruding peripheral edge being advantageously suitable to define means for conveying the infusion liquid towards the central zone of the product.

This considerably facilitates the filtering of the infusion liquid through the innermost area of the product, that is to say, in such a way such as to cross the maximum possible part of the raw infusion material.

Advantageously, the infusion product 15 comprises, not illustrated in detail in the accompanying drawings, an outer protective wrapper or flavour-save wrapper, preferably made of aluminium film, which is preferably made from two wrapping sheets facing each other and preferably sealed to each other and, lastly, preferably twisted around the product 11.

The aluminium film can be advantageously opened, in particular by tearing, to allow access to the infusion product 11, which is then positioned in the respective adapter container 12, which will be described in more detail below.

As illustrated, advantageously, the infusion product 11 has a longitudinal length or height which is greater than half the width or diameter of the infusion product 11.

In this way, a maximum volume of infusion material is obtained which guarantees that an excellent drink is obtained for the consumer.

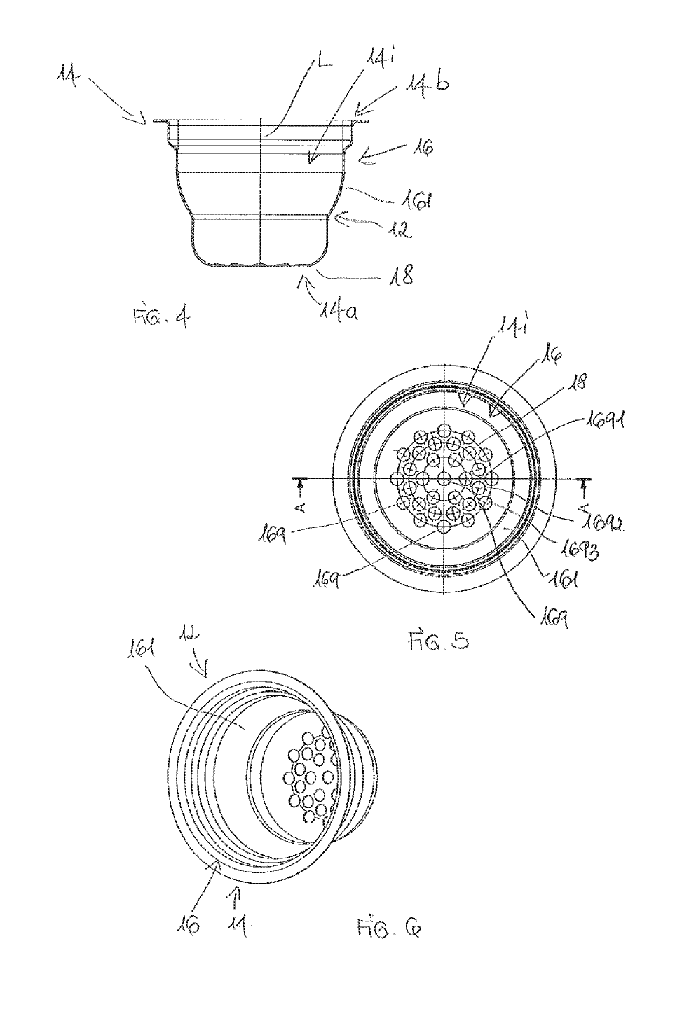

FIGS. 4 to 6 also illustrate an advantageous container, in particular adapter container, 12 for housing a product 11 for making, through infusion, a respective drink, in particular a hot drink, especially in the form of coffee.

The drink is preferably obtained by means of a respective machine which uses an infusion liquid, which is in particular in the form of water, especially in the form of hot water.

The container 12 is designed to be inserted in a respective seat of the corresponding infusion machine, and has outside dimensions, and/or a shape, which are suitable for insertion in the seat of the infusion machine.

As illustrated, the container 12 comprises a body 14 of the container, extending, positioned according to a respective longitudinal axis L between opposite ends 14a, 14b of the body of the container, and which is internally hollow so as to define a chamber 14i for housing the infusion product 11, the chamber 14i being, as illustrated, delimited by a respective perimeter wall 16 of the container body.

Advantageously, the perimeter wall 16 of the body of the container 14 has a corresponding portion 161, which defines means for retaining the infusion product.

Advantageously, the same portion 161 extends longitudinally and is shaped converging towards the respective longitudinal end 14a of the container body 14 and is designed to engage the corresponding outer surface 11′ of the infusion product 11.

Advantageously, the convergent portion 161 of the peripheral wall 16 of the container body is formed by a corresponding sphere-like profile.

More specifically, the convergent portion 161 of the peripheral wall 16 of the container body is defined by a corresponding perimeter profile curved and concave towards the inside of the chamber 14i for housing the product, that is, curved with the respective concavity facing towards the inside of the chamber 14i for housing the product.

As illustrated, advantageously, the convergent portion 161 is located at an intermediate area of the peripheral wall 16.

As illustrated, the body 14 of the container has a respective transversal closing wall 18, at a respective end 14a of the container body, in particular at the end of greatest reduced diameter of the body of the container, that is to say, at the end of escape of the infused drink.

As illustrated, advantageously, the body 14 of the container has a respective open end 14b.

As illustrated, the peripheral wall 16 of the body of the container has an end portion 162, preferably cylindrical, which extends between the portion and the respective end of the container body, in particular the respective transversal end closing wall 18.

More specifically, as illustrated, between the respective closing wall 18 and the perimeter wall 16, in particular the cylindrical end portion 162 of this, there is a peripheral curved connecting portion 168.

As illustrated, advantageously, the convergent portion 161 of the peripheral surface 16 of the container 14 extends from a corresponding portion 161″ of the peripheral wall which is designed to engage a corresponding cylindrical portion of the infusion product 11.

As illustrated, between the respective open end 14b and the surface 161, 161″ of the perimeter, or peripheral, surface 16 of the container body there is a diverging or conical peripheral portion 163, from which extends a corresponding cylindrical portion 164, or a corresponding peripheral lip 165, radially protruding towards the outside of the chamber 14i housing the product 11, in particular, as illustrated, the lip 165 extending from the end cylindrical portion 164.

As illustrated, the open end 14b of the container body 14 is closed by a corresponding cover 17, which can be engaged with and disengaged from the container body, to allow the introduction and the removal of the infusion product 11 from the housing chamber 14i.

More specifically, the cover 17 can be engaged with and disengaged from the peripheral wall 16 of the container body, especially with the respective cylindrical portion 164 thereof, that is, with the inner face of this cylindrical end portion 164.

As illustrated, advantageously, the cover 17 carries corresponding means 161 for connecting to the supporting body 14, in particular with the perimeter wall 16 of this, and preferably with the cylindrical end portion 164 thereof.

As illustrated, the cover 17 comprises a wide disk-shaped portion 172, from which extends axially a corresponding axial portion 173 of reduced width or diameter relative to the disc-shaped portion 172.

More specifically, the connecting means 171 are provided on the respective axial portion 173 of the cover 17.

More specifically, as illustrated, the connecting means 171 are in the form of corresponding elastic means for engaging with the corresponding inner surface of the container body 14, in particular with the end portion of the respective peripheral wall 16 of the container body.

More specifically, as illustrated, the connecting means 171 are in the form of a corresponding O-ring 175, and in any case might also be defined by a corresponding thread for coupling with a contrasting thread provided on the container body 14, in particular on the inner face of the end portion of the respective peripheral wall 16, that is to say, also by other connecting means.

The threaded connecting means are not illustrated in detail in the accompanying drawings.

As illustrated, the O-ring 175 is inserted in a suitable recessed groove on the protruding axial portion 173 of the cover 17.

As may be inferred from the drawings, the cover 17 has an end lip, or peripheral end portion, 172′, which is located at and preferably rests on a corresponding protruding peripheral lip 165 of the container body 14.

In use, the axial portion 173 of cover lid 17, extends inside the perimeter wall 16, in particular the end portion 164 thereof.

As illustrated, advantageously, the cover 17 comprises respective hole means 179, in particular in the form of a single hole, preferably central or on the longitudinal axis L of the container body, for the introduction of corresponding means for the emission of the infusion liquid in the chamber for housing the infusion product 11.

As illustrated, the cover 17 has, on the outer side, at the respective perforated central area, a corresponding portion 170 which is recessed relative to the outer surface of the cover 17, the recessed portion extending coaxially around the hole 179 provided in the cover 17.

As illustrated, advantageously, the respective transversal end wall 18 of the body of the container 14 has corresponding hole means 169 for the outflow of the infused drink.

As illustrated, advantageously, the hole means 169 comprise a plurality of holes passing through the transversal end wall 18.

More specifically, as illustrated, the respective hole 169 has a diameter substantially equal to 3 mm. More specifically, all the holes of the plurality of through holes of the preferred embodiment have the same diameter.

Moreover, as illustrated, the plurality of through holes 169 comprises a central hole 169 and a plurality of holes, peripherally distributed around the central hole.

The plurality of holes 169 comprises a first plurality of holes 1691, arranged on a first circumference, and, preferably, a second plurality of holes 1692 arranged on a second circumference, with a diameter greater than the first circumference, as well as, if desired, a third plurality of holes, 1693 arranged on a third circumference with a diameter greater than that of the second circumference.

As illustrated, advantageously, the holes of the first and third circumference are radially aligned with each other, whilst the holes of the second circumference are circumferentially or angularly offset relative to the holes of the third circumference.

Advantageously, the body of the container and/or the respective closing cover may be made of metallic material and/or plastic material, preferably rigid.

According to a further preferred embodiment of the container, not illustrated in the accompanying drawings, and which in any case has the same shape as the container described above, the body 14 of the container of this further preferred embodiment is made of plastic material, preferably made of thermoformed plastic material, and/or a material which creates a barrier to the environment outside the container. In this case, the body of the container 14 would preferably be free of holes, in particular at the respective transversal end wall 18 of the body of the container.

In this further preferred embodiment of the container, the respective cover for closing the open end of the container body 14, could comprise, or be replaced by, a single film, made of barrier material, preferably aluminium film, or a corresponding multi-layer film, the film extending transversally to close the open end of the container body 14.

The closing film may be coupled to the body of the container, adhering to the transversal surface of the corresponding radially protruding peripheral lip 165. The closing film being obviously completely free of corresponding hole means, which on the other hand, are provided in the cover of the previous preferred embodiment.

In this way, an infusion capsule is obtained, preferably sealed relative to the outside environment, and containing, inside the container the above-mentioned infusion product 11, the capsule designed for use in a corresponding infusion machine, to obtain a corresponding drink. In this case, the infusion machine perforates, in suitable manner, the body of the container and/or the corresponding closing film of the respective open end of the container body, to allow the passage of the water preferably hot into the container body and in contact with the product 11 and therefore allowing infusion of the product in the water.

The invention described has evident industrial applications. It would be obvious to one skilled in the art that several changes and modifications can be made to the invention without departing from the spirit and scope of the invention, described in depth above. It is also easy to imagine further embodiments of the invention comprising one or more of the features described herein. Moreover, it will be understood that all the details of the invention may be substituted for technically equivalent elements.

1) A product for making, through infusion, a respective drink, in particular a hot drink, especially coffee. the drink being preferably obtained by making the infusion in a respective machine which uses an infusion liquid, which is in particular in the form of water, especially in the form of hot water; the product comprises a raw infusion material, preferably in the form of roasted and ground coffee, which is preferably designed to be housed in a suitable infusion container, in particular in the form of an adapter container; wherein the raw infusion material has a compacted configuration, that is, it has the respective constituent particles which adhere to each other; and wherein the infusion product extends along an axial direction between opposite longitudinal ends and has a peripheral surface, or part of this, which extends longitudinally and is convergent towards a respective longitudinal end and is designed to engage a corresponding inner profile of the infusion container.

2) The product according to claim 1, wherein it comprises a film made of biodegradable or bio-compostable filtering material, in particular food safe, preferably PLA, which surrounds the compact raw material, more specifically defining the outer surface of the product, preferably wrapping entirely around the raw infusion material.

3) The product according to claim 1, wherein it has a peripheral surface, or part of this, which is hemispherical or generally hemispherical in shape.

4) The product according to claim 1, wherein it has a portion of the peripheral surface which is cylindrical or generally cylindrical in shape, in particular the hemispherical or generally hemispherical portion extending from the cylindrical or generally cylindrical portion.

5) The product according to claim 1, wherein the product has a large end face, in particular flat.

6) The product according to claim 2, wherein the wrapping film defines the end face of the product, in particular having a hemispherical or generally hemispherical configuration, and if necessary a cylindrical or generally cylindrical portion.

7) The product a according to claim 2, wherein the wrapping film defines the flat end face of the product.

8) The product according to claim 2, wherein the wrapping film adheres to the raw infusion material, in particular in particular adhering completely to the outer lateral surface of the raw material and/or the transversal end surface of the raw material, that is to say, adhering to the entire surface of the raw material.

9) The product according to claim 1, wherein the tablet of raw infusion material, in particular with the wrapping film adhering to this, is obtained from respective particles, in particular powder, granules, pieces and/or the like, and which are preferably inserted in the film, and subjected to ultrasound energy.

10) The product according to claim 1, wherein the wrapping film has a protruding peripheral edge, in particular defining means for conveying the infusion liquid towards the central area of the product.

11) The product according to claim 1, wherein the infusion product comprises a protective wrapper, preferably made of aluminium film.

12) The product according to claim 1, wherein the infusion product has a longitudinal length or height which is greater than half the width or diameter of the infusion product.

13) A container for the infusion of a respective product for making, through infusion, a respective drink, in particular a hot drink, especially coffee; the drink being preferably obtained through a respective machine which uses an infusion liquid, which is in particular in the form of water, especially in the form of hot water, the container being designed to be inserted a respective seat of the infusion machine; the container comprises a body which extends along a respective longitudinal axis between opposite longitudinal ends and which is internally hollow so as to define a respective chamber for housing the infusion product, the chamber being delimited by a respective perimeter wall of the container body, wherein the perimeter wall has a corresponding portion defining means for retaining the infusion product, the portion extending longitudinally and convergent towards a respective longitudinal end of the container body and designed to engage a corresponding outer surface of the infusion product.

14) The container according to claim 13, wherein the convergent portion of the peripheral wall of the body of the container is defined by a corresponding sphere-like profile.

15) The container according to claim 13, wherein the convergent portion of the peripheral wall is defined by a corresponding curved perimeter profile with the respective concavity facing inside the chamber for housing the product.

16) The container according to claim 13, wherein the convergent portion is at an intermediate area of the peripheral wall.

17) The container according to claim 13, wherein the body of the container has a respective transversal closing wall, at a respective end of the body of the container.

18) The container according to claim 17, wherein the respective transversal wall is in a single body with the perimeter wall.

19) The container according to claim 13, wherein the body of the container has a respective open end wall.

20) (canceled)

21) (canceled)

22) The container according to claim 13, wherein the convergent portion of the peripheral surface of the container body extends from a corresponding portion which is designed to engage a corresponding cylindrical portion of the infusion product.

23) (canceled)

24) The container according to claim 13, wherein the open end of the container body is closed by a corresponding cover which can be engaged and disengaged with the container body, in particular with the perimeter peripheral wall of the container body, especially with the respective cylindrical end portion.

25) (canceled)

26) (canceled)

27) (canceled)

28) (canceled)

29) (canceled)

30) The container according to claim 21, wherein the cover comprises respective hole means, in particular in the form of a single hole, preferably central or on the longitudinal axis of the container body, for the introduction of corresponding means for the emission of the infusion liquid in the chamber for housing the infusion product.

31) (canceled)

32) (canceled)

33) (canceled)

34) (canceled)

35) (canceled)

36) (canceled)

37) (canceled)

38) (canceled)

39) (canceled)

40) (canceled)

41) (canceled)
